(19) United States
(12) Patent Application Publication
(10) Pub. No.: US 2016/0308744 A1
(43) Pub. Date: Oct. 20, 2016

(54) METHOD AND SYSTEM FOR COLLECTING INFORMATION ABOUT USAGE OF A WEB PROPERTY

(71) Applicant: Super Analytics Oy, Turku (FI)

(72) Inventors: Kalle Heinonen, Turku (FI); Jarkko Niemelä, Lieto (FI); Ville Honkanen, Turku (FI); Jan Koivukangas, Raisio (FI); Ville Virtanen, Turku (FI)

(21) Appl. No.: 14/688,674

(22) Filed: Apr. 16, 2015

(51) Int. Cl. H04L 12/26; H04L 29/08

(52) U.S. Cl. CPC H04L 43/0876; H04L 67/02; H04L 67/22; H04L 67/142

(57) ABSTRACT

Disclosed is a method for collecting information about usage of a web property. The method comprises receiving a request from a visitor's computing device to access the web property. The method also comprises determining an occurrence of at least one predefined condition associated with the web property. The method further comprises selecting a tracking identifier from a plurality of tracking identifiers associated with the web property based on the occurrence of the at least one predefined condition and generating a script comprising the selected tracking identifier and instructions to determine usage of the web property at the visitor's computing device. The method also comprises transmitting the web property embedded with the script and content to the visitor's computing device.

### TECHNICAL FIELD

The present disclosure relates generally to web analytics methods and systems; and more specifically, to methods and systems for collecting information about usage of a web property.

### BACKGROUND

Generally, publishers use a web analytics system (e.g., Google Analytics) to measure, collect, analyze and report web data to interpret and optimize usage of a web property. The web analytics system generates a tracking ID for the web property and provides a script to a web server. The script includes instructions to measure usage of the web property. The web server embeds the tracking ID and the script within content (e.g., a hyper text mark language (HTML) code) of the web property. On receiving a request to access the web property from a visitor's computing device, the web server transmits the web property to the visitor's computing device. The script is executed by a browser of the visitor's computing device and usage data for the web property is determined and delivered to a statistics server of the web analytics system.

This process of collection of the usage data is performed for every visitor's access to the web property. Consequently, popular web properties generate huge amount of usage data which needs to be stored appropriately. However, existing statistics servers are usually discards the usage data when a maximum usage data collection limit for the tracking ID has reached. As a result, the publishers lose the discarded usage data for the popular web properties and obtain inaccurate analysis from the web analytics system.

Further, the web analytics system requires retrieval of the usage data from the statistics server based on the tracking ID of the web property. In case the web property is a popular web property, the web analytics system requires high speed computing resources to retrieve and process the huge amount of the usage data associated with the popular web property. Otherwise, the operational efficiency of the system is severely affected. Furthermore, publishers owning popular web sites may have thousands of tracking IDs for the web property. The existing web analytics system provides no support to effectively manage the usage data from the plurality of tracking IDs in the dashboard.

Therefore, in light of the foregoing discussion, there exists a need to provide a method and system for efficiently collecting the usage data corresponding to plurality of tracking IDs of the web property.

### SUMMARY

The present disclosure seeks to provide a method for collecting information about usage of a web property.

The present disclosure also seeks to provide a system for collecting information about usage of a web property.

In one aspect, an embodiment of the present disclosure provides a method for collecting information about usage of a web property. The method comprising steps of:

receiving a request from a visitor's computing device to access the web property;

determining an occurrence of at least one predefined condition associated with the web property;

selecting a tracking identifier from a plurality of tracking identifiers associated with the web property based on the occurrence of the at least one predefined condition;

generating a script comprising the selected tracking identifier and instructions to determine usage of the web property at the visitor's computing device; and

transmitting the web property embedded with the script and content to the visitor's computing device.

In another aspect, an embodiment of the present disclosure provides a method for collecting information about usage of a web property. The method comprising steps of:

receiving a request from a web server to deliver a tracking identifier from a plurality of tracking identifiers associated with the web property, wherein the tracking identifier is to be enclosed in a script which is to be embedded in the web property required to be sent to a visitor's computing device;

determining an occurrence of a predefined condition corresponding to usage of the web property;

sending the web server a first tracking identifier from the plurality of tracking identifiers when the predefined condition has not occurred and a second tracking identifier from the plurality of tracking identifiers when the predefined condition has occurred; and

receiving the usage data of the web property generated on execution of the script at the visitor's computing device.

In a yet another aspect, an embodiment of the present disclosure provides a method for collecting information about usage of a web property. The method comprising steps of:

transmitting a request to access the web property from a visitor's computing device;

receiving the web property from a web server wherein the web property comprises a script which includes a first tracking identifier corresponding to the web property when a predefined condition has not occurred and a second tracking identifier corresponding to the web property when the predefined condition has occurred;

executing the script to collect information about usage of the web property at the visitor's computing device; and

transmitting the usage data generated on execution of the script to a statistic collection server.

In another aspect, an embodiment of the present disclosure provides a system for collecting information about usage of a web property. The system comprises an analytics server configured to deliver a code including instructions to select a tracking identifier from a plurality of tracking identifiers associated with the web property and a visitor's computing device configured to transmit a request to access the web property. The system also comprises a web server configured to:
receive the request to access the web property;
determine an occurrence of at least one predefined condition associated with the web property;
execute the code to select the tracking identifier from the plurality of tracking identifiers based on the occurrence of the at least one predefined condition;
generate a script comprising the selected tracking identifier and instructions to determine usage of the web property at the visitor's computing device; and
transmit the web property embedded with the script and content to the visitor's computing device.

Embodiments of the present disclosure substantially eliminate or at least partially address the aforementioned problems in the prior art, and enable efficiently management of the usage data corresponding to the plurality of tracking identifiers of the web property.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a web analytics system; in accordance with an embodiment of the present disclosure;

FIG. 2 is an illustration of steps of a method for avoiding quota limits of a statistics server on the usage data of a web property, in accordance with an embodiment of the present disclosure;

FIG. 3 is an illustration of a signalling flow for collecting information about usage of the web property, in accordance with an embodiment of the present disclosure; and

FIG. 4 is an illustration of steps of a method for presenting usage information of the web property, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

In an aspect, an embodiment of the present disclosure provides a method for collecting information about usage of a web property, the method comprising steps of:

receiving a request from a visitor's computing device to access the web property;

determining an occurrence of at least one predefined condition associated with the web property;

selecting a tracking identifier from a plurality of tracking identifiers associated with the web property based on the occurrence of the at least one predefined condition;

generating a script comprising the selected tracking identifier and instructions to determine usage of the web property at the visitor's computing device; and

transmitting the web property embedded with the script and content to the visitor's computing device.

In another aspect, an embodiment of the present disclosure provides a method for collecting information about usage of a web property, the method comprising steps of:

receiving a request from a web server to deliver a tracking identifier from a plurality of tracking identifiers associated with the web property, wherein the tracking identifier is to be enclosed in a script which is to be embedded in the web property required to be sent to a visitor's computing device;

determining an occurrence of a predefined condition corresponding to usage of the web property;

indicating the web server a first tracking identifier from the plurality of tracking identifiers when the predefined condition has not occurred and a second tracking identifier from the plurality of tracking identifiers when the predefined condition has occurred; and

receiving the usage data of the web property generated on execution of the script at the visitor's computing device.

In another aspect, an embodiment of the present disclosure provides a method for collecting information about usage of a web property, the method comprising the steps of:

transmitting a request to access the web property from a visitor's computing device;

receiving the web property from a web server wherein the web property comprises a script which includes a first tracking identifier corresponding to the web property when a predefined condition has not occurred and a second tracking identifier corresponding to the web property when the predefined condition has occurred;

executing the script to collect information about usage of the web property at the visitor's computing device; and

transmitting the usage data generated on execution of the script to a statistic collection server.

In another aspect, an embodiment of the present disclosure provides a web analytics system for collecting information about usage of a web property. The system comprising:

an analytics server configured to deliver a code including instructions to select a tracking identifier from a plurality of tracking identifiers associated with the web property;

a visitor's computing device configured to transmit a request to access the web property; and

a web server configured to:
receive the request to access the web property;
determine an occurrence of at least one predefined condition associated with the web property;
execute the code to select the tracking identifier from the plurality of tracking identifiers based on the occurrence of the at least one predefined condition;
generate a script comprising the selected tracking identifier and instructions to determine usage of the web property at the visitor's computing device; and
transmit the web property embedded with the script and content to the visitor's computing device.

In an embodiment, the web property can correspond to web presence of a publisher. For example, the web property can indicate a website including one or more web pages, blogs, multimedia applications, and among other resources that can assist in establishing the web presence of the publisher. The usage of the web property refers to the information associated with an interaction pattern of a visitor accessing the web property. For example, the interaction pattern may indicate page views of the web property, session duration, visitor's behaviour or location, access timings, browser details and among other interaction related information.

The web analytics system comprises a visitor's computing device, a web server, an analytics server, and a statistics server configured to communicably connect with each other through a network. The network can be a wired, wireless, or a combination thereof. Examples of such network includes, but are not limited to, Local Area Networks (LANs), Wide Area Networks (WANs), Metropolitan Area Networks (MANs), Wireless LANs (WLANs), Wireless WANs (WWANs), Wireless MANs (WMANs), the Internet, second generation (2G) telecommunication networks, third generation (3G) telecommunication networks, fourth generation (4G) telecommunication networks, and Worldwide Interoperability for Microwave Access (WiMAX) networks.

In an embodiment, the analytics server is configured to define a plurality of tracking IDs for the web property. Each tracking ID can correspond to a category which can assist the analytics server in analysis of the usage data. The category can be based on attributes of the visitor's computing device, traffic parameters, type of the statistics server and its limiting parameters, and combination thereof. For example, in a browser based category, the analytics server is configured to define a tracking ID 1 and a tracking ID 2 for “Mozilla Firefox” and “Safari” respectively. In another example, the analytics server is configured to generate a new tracking ID after regular intervals (e.g., daily) due to high traffic volumes for the web property.

The analytics server is configured to manage the plurality of tracking IDs of the web property. The analytics server may build a database of the tracking IDs associated with the web property. The database includes detailed information about the generation, usage and validity of the tracking IDs. For example, the database may comprise entries related to the tracking ID 3 indicating that the tracking ID 3 was generated on Mar. 1, 2015, assigned to the web property from Mar. 3, 2015 to Mar. 5, 2015 and is no longer valid. The analytics server can utilize this information associated with the tracking IDs of the web property while retrieving usage data from the statistics server.

According to an embodiment, the analytics server is configured to assign a specific tracking ID with the web property during a communication session between the visitor's computing device and the web server. The analytics server provides the assigned tracking ID and a script to the web server in order to track the usage of the web property with the tracking ID. Whenever the visitor's computing device submits a request to the web server to access the web property, the web server is configured to embed the script and the tracking ID within the web property before delivering it to the visitor's computing device.

In an example, the script can be a java script and can include instructions in a following manner.

<script type=“text/javascript”>
vargaJsHost = ((“https:” == document.location.protocol) ?
“https://ssl.” : “http://www.”);
document.write(unescape(“%3Cscript src=‘” + gaJsHost +
“google-analytics.com/ga.js’ type=‘text/javascript’%3E%3C/script%3E”));
</script>
<script type=“text/javascript”>
try {
_gaq.push([‘_setAccount’,ID]);
_gaq.push([‘_setDomainName’,‘.acme.xxx’]);
_gaq.push([‘_addIgnoredOrganic’,‘.acme.xxx’]);
_gaq.push([‘_trackPageview’]);
} catch(err) { }</script>

The ID in the script corresponds to the tracking ID. The visitor's computing device executes the script to determine information about usage of the web property. The visitor's computing device is configured to deliver the usage information and the tracking ID associated with the web property to the statistics server. In an embodiment, the statistics server can include one or more servers operating in a cloud computing environment to store real time information associated with the usage data per tracking ID of the web property.

According to an embodiment, the analytics server is programmed to determine a need to change the assigned tracking ID to the web property with a new tracking ID based on an occurrence of one or more predefined conditions. Alternatively, the web server can be programmed to request the analytics server to determine as to whether there exists a need to replace the assigned tracking ID with the new tracking ID for the web property. If a particular predefined condition has occurred, the analytics server is configured to indicate the web server to replace the assigned tracking ID with the new tracking ID, otherwise, the analytics server may indicate the web server to retain the existing tracking ID.

Further, the analytics server may define one or more parameters and its threshold values to determine the occurrence of the one or more predefined conditions. The one or more parameters can be an indicative of the usage data corresponding to the tracking ID of the web property. The parameters may include number of hits per month, number of hits per visitor per day, validity period of the tracking ID and combination thereof. Further, the analytics server is configured to query the statistics server to extract current value of the one or more parameters. The analytics server is configured to compare the current and threshold values of the parameter and determine the occurrence of the predefined condition.

In an example, the analytics server may define a threshold value for the number of hits per month for the tracking ID 4 as 100 million per month. If the current value of the number of hits per month for the tracking ID 4 is greater than the 100 million per month, the analytics server is configured to indicate to the web server to replace the tracking ID 4 with a new tracking ID 5 for the web property. Similarly, the analytics server may set the validity period for a tracking ID 6 to be 15 days. The analytics server may determine the remaining validity period of the tracking ID 6 and indicate to the web server to start using a new tracking ID 7 for the web property on expiration of the validity period of 15 days. As discussed above, the analytics server is configured to store such changes of assigning the new tracking ID to the web property in the database for later use.

According to an embodiment, the analytics server transmits a code comprising instructions for the web server to determine the occurrence of the predefined condition based on the current value of the parameters. As a result, the web server can be programmed to submit a query to the statistics server to determine current value for the no of hits per visitor per day for an assigned tracking ID 8, when the visitor's computing device submits a request to access the web property. On receiving the current value of the no. of hits per visitor per day, the code enables the web server to compare the current and threshold values to determine validity of the assigned tracking ID 8. If the current value exceeds the threshold value for the no. of hits per visitor per day, the code enables the web server to replace the assigned tracking ID 8 with a new tracking ID 9.

In an embodiment, the analytics server is configured to define tracking IDs for the web property corresponding to attributes of the visitor's computing device. The attributes of the visitor's computing device can include source, medium, timing of the request, geographical location of the visitor's computing device, type of the visitor's computing device, a web browser, traffic source dimensions and combinations thereof. Based on the current status of attribute associated with the visitor's computing device, an occurrence of the predefined condition is determined and subsequently, an appropriate tracking ID from the plurality of tracking IDs is selected.

The web server is configured to request the analytics server to deliver a code including instructions to select the tracking ID from the plurality of tracking IDs in accordance with the attributes of the visitor's computing device. Accordingly, the analytics server delivers the code to the web server and a list of plurality of tracking IDs of the web property. For example, a visitor's computing device submits a request to access a particular web page and the web server is configured to determine source of the visitor's request. The source can be a direct source when the visitor has directly typed the URL of the web page in the browser or an indirect source when the visitor has requested the URL through another site. Based on the type of the source of the request, the code enables the web server to select a tracking ID 10 from the list of plurality of tracking IDs.

In an alternate embodiment, the web server is configured to transmit the identified attribute of the visitor's computing device to the analytics server which determines the tracking ID in accordance with the attribute. For example, the web server determines that visitor's computing device is located in US and subsequently, transmits the location information of the visitor's computing device to the analytics server. The analytics server identifies the tracking ID from the list of plurality of tracking IDs when the visitor is from US. The analytics server transmits the identified tracking ID to the web server. In addition, the web server can be programmed to communicate with the analytics server to automatically receive validity status of the tracking IDs available in the list of the plurality of tracking IDs after a predetermined period. In an example, the predetermined period can be 24 hours. On receiving the validity status from the analytics server, the web server can select any valid tracking ID for the web property depending on the attribute of the visitor's computing device.

Further, the web server is configured to embed the tracking ID and the script within the web property and transmit the web property to the visitor's computing device. The script is executed at the visitor's computing device to determine the usage of the web property at the visitor's computing device. Thus, the present disclosure enables the visitor's computing device to receive the web property from a web server wherein the web property comprises a script which includes a first tracking ID corresponding to the web property when a predefined condition has not occurred and a second tracking ID corresponding to the web property when the predefined condition has occurred. For example, the visitor's computing device may receive the web property including a tracking ID 11 when the browser of the visitor's computing device is “FireFox”, and the visitor's computing device may receive a tracking ID 12 when the browser of the visitor's computing device is “Google Chrome”.

The visitor's computing device is configured to deliver the information and the tracking ID to the statistics server. The statistics server tags the received information with the tracking ID of the web property while storing in its database. Whenever a query is received at the analytics server to view the usage of the web property, the analytics server is configured to analyze the received query to identify tracking IDs from the plurality of tracking IDs for which data needs to be extracted from the statistics server. For example, the query may include instructions to display usage of the web property in US. The analytics server will identify the tracking ID assigned for US location and submit data extraction request to the statistics server for the identified tracking ID. On receiving data from the statistics server, the analytics server is configured to display the usage information at client's computing device.

The tagging of the usage data with the tracking ID enables the system to segment the usage data into one or more data sets. As the analytics server is aware of the association of the data sets with the respective tracking IDs, the analytics server is configured to retrieve only those data sets which are required to display the usage information at the client's computing device. As a result, the present disclosure increases the processing capabilities of the analytics server. Further, the extracted data may be represented directly to the client's computing device and thereby, reducing the analysis time for the analytics server. For example, if the client's computing device has requested the analytics server to display usage statistics of the web property browsed on a mobile device, the analytics server, instead of retrieving complete data from the statistics server, may identify the tracking ID corresponding to device type category for the web property. Accordingly, the analytics server presents the information to the client's computing device.

According to an embodiment, the analytics server is configured to distribute the usage data for the tracking IDs across different statistics servers. For example, the analytics server may allocate a first statistics server to store the usage data when the visitor's computing device is from US and a second statistics server to store the usage data when the visitor's computing device is from Europe. Subsequently, when the client's computing device submits a request to view US and Europe based usage data, the analytics server retrieves the data from the first statistics server and the second statistics server for US and Europe usage data respectively. Further, when the client's computing device request to view complete usage data for the web property, the analytics server combines the retrieved data from the first and second statistics servers and displays the information to the client's computing device. Such type of division of the usage data across different statistics server increases the security and protection for the data.

The methods and systems disclosed in the present disclosure offers several advantages. For example, for heavy traffic based web property, dynamically shifting from one tracking ID to another tracking ID enables the analytics server to avoid quota limits of the statistics server. As a result, the analytics server is still able to capture the usage data corresponding to the web property, otherwise which may not have been possible as the statistics server ignore the usage data once it crosses beyond the quota limit set for a single tracking ID. Further, usage of the plurality of tracking IDs for the web property enables the analytics server to control the “granularity” of the data that needs to be extracted from the statistics server. As a result of fragmentation of the usage data, the analytics server is configured to retrieve and combine usage data from the one or more statistics servers in a highly efficient manner.

### DETAILED DESCRIPTION OF THE DRAWINGS

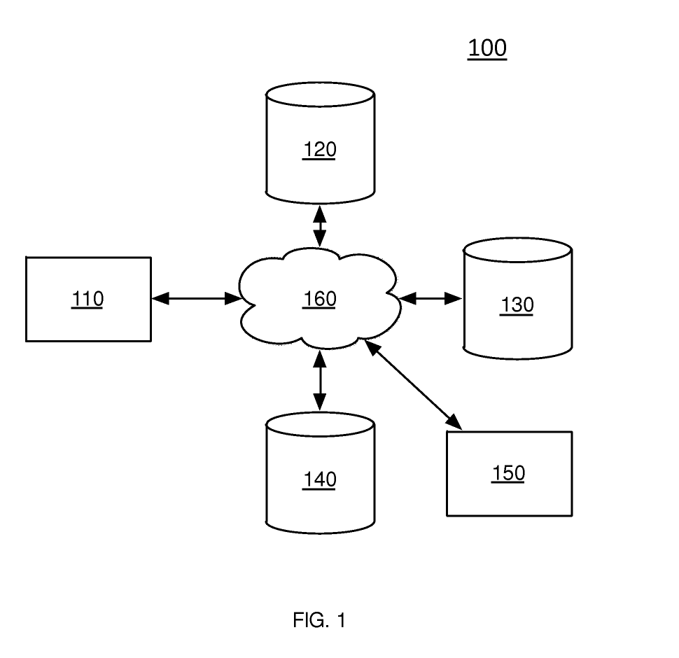

Referring now to the drawings, particularly by their reference numbers, FIG. 1 is a schematic illustration of a web analytics system 100 for collecting information about usage of a web property in accordance with an embodiment of the present disclosure. The web analytics system 100 comprises a visitor's computing device 110, a web server 120, and a statistics server 130, an analytics server 140, and a client's computing device 150 communicably connected through a network 160. The analytics server 140 is configured to generate and manage a plurality of tracking IDs for the web property. Each tracking ID can correspond to a category which can assist the analytics server 140 in analysis of the usage data. The visitor's computing device 110 submits a request to the web server 120 to access the web property. The analytics server 140 delivers a code including instructions for the web server 120 to select a tracking ID from the plurality of tracking IDs based on occurrence of predetermined conditions which are determined using one or more usage parameters of the web property or attributes of the visitor's computing device 110.

Further, the web server 120 is configured to include a script comprising instructions to track the usage of the web property and the selected tracking ID within the web property which is forwarded to the visitor's computing device 110. A web browser application at the visitor's computing device 110 executes the script and visitor's computing device 110 forwards the usage data including the tracking ID to the statistics server 130. The statistics server 130 collects usage data for each tracking ID corresponding to the web property. Further, the analytics server 140 is configured to retrieve usage data corresponding to the tracking ID from the statistics server 130 for presentation in a dashboard.

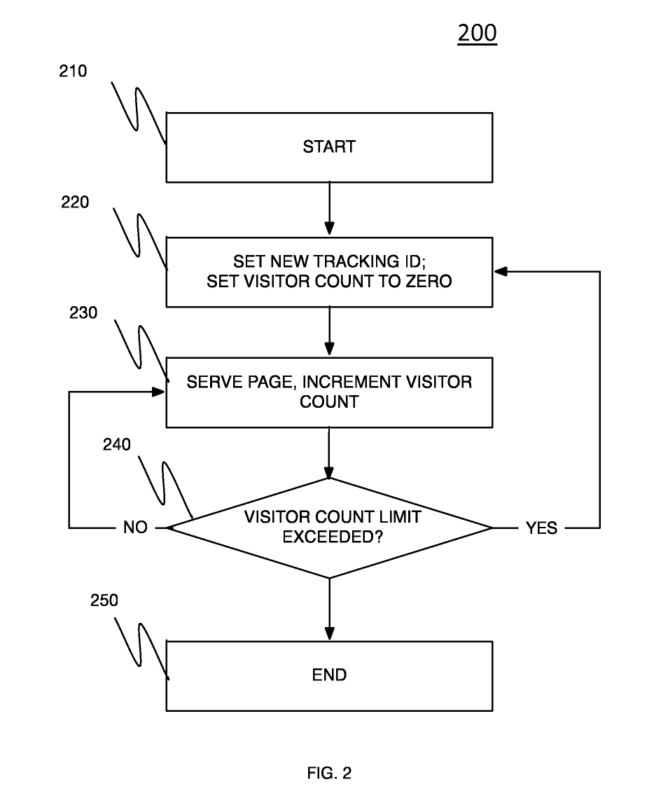

Referring now to FIG. 2, illustrated are steps of a method 200 for avoiding quota limits of the statistics server 130 for the usage data of the web property. The method 200 illustrates steps involved in the operation of the web server 120 or analytics server 140 of the FIG. 1 in order to dynamically shift to a new tracking ID for the web property. The method 200 initiates at step 210.

At step 220, a new tracking ID is set for the web property and a visitor count for the new tracking ID is set to zero.

At step 230, the web server 120 delivers the web property to the visitor's computing device 110 and increments the visitor count.

At step 240, a determination is made as to whether the visitor count has exceeded a visitor count limit. The method 200 proceeds to step 220, if it is determined that increased visitor count has exceeded the visitor count limit. At step 220, the web server 120 or analytics server 140 is configured to reset the visitor count to zero and reassign a new tracking ID to the web property. That is to say, the method 200 is configured to replace the existing tracking ID of the web property with the new tracking ID on finding that the visitor counts for the existing tracking ID has exceeded the visitor count limit.

The method 200 proceeds to step 250, if it is determined that the visitor count has not exceeded the visitor count limit. At step 250, the method 200 terminates. The method 200 ensures that quota limits of the statistics server 130 does not exceed for the tracking ID of the web property.

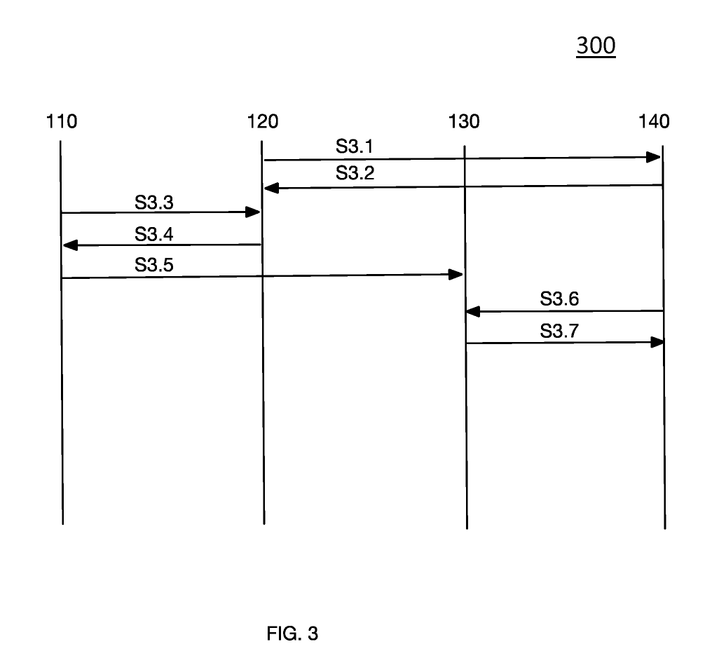

Referring now to FIG. 3, illustrated are steps of a signalling flow 300 for collecting information about usage of the web property, in accordance with an embodiment of the present disclosure. At step 3.1, the web server 120 is configured to submit a request to the analytics server 140 to provide a script comprising instructions to track the usage of the web property and plurality of tracking IDs associated with the web property.

At step 3.2, the analytics server 140 delivers the script and the plurality of tracking IDs of the web property. The analytics server 140 is configured to provide a code including instructions to select a tracking ID from the provided tracking IDs on occurrence of a predefined condition. At step 3.3, the visitor's computing device 110 submits a request to access the web property to the web server 120. At step 3.4, the web server 120 transmits the web property including the script and the selected tracking ID to the visitor's computing device 110.

At step 3.5, the visitor's computing device 110 the usage information generated on execution of the script and the tracking ID to the statistics server 130. At step 3.6, the analytics server 140 submits a query to the statistics server 130 to extract information based on the tracking ID to display the tracking ID based information on the client's computing device 150. At step 3.7, the statistics server 130 forwards the information associated with the tracking ID of the web property to the analytics server 140.

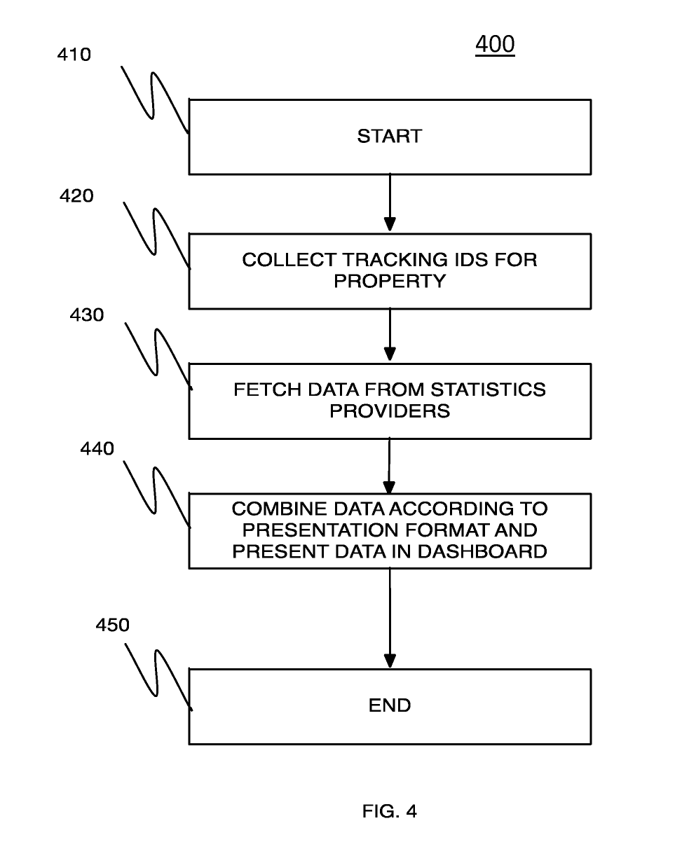

Referring now to FIG. 4, illustrated are steps of a method 400 for presenting usage information of the web property, in accordance with an embodiment of the present disclosure. The method 400 illustrates steps involved in the operation of the analytics server 140 of the FIG. 1, when the client's computing device 150 submits a query to display usage information of the web property. At step 410, the method 400 initiates and proceeds to step 420.

At step 420, the analytics server 140 is configured to collect tracking IDs of the web property for which usage data needs to be extracted from the statistics server 130. At step 430, the analytics server 140 is configured to retrieve the usage data from the statistics server 130 based on the collected tracking IDs of the web property.

At step 440, the analytics server 140 combines the data in accordance with the presentation format and presents the data in a dashboard. At step 450, the method 400 terminates.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for collecting information about usage of a web property, the method comprising steps of:
receiving a request from a visitor's computing device to access the web property;
determining an occurrence of at least one predefined condition associated with the web property;
selecting a tracking identifier from a plurality of tracking identifiers associated with the web property based on the occurrence of the at least one predefined condition;
generating a script comprising the selected tracking identifier and instructions to determine usage of the web property at the visitor's computing device; and
transmitting the web property embedded with the script and content to the visitor's computing device.

2. A method according to claim 1, further comprising:
receiving at least one attribute corresponding to the visitor's computing device; and
determining the occurrence of the at least one predefined condition in accordance with the at least one attribute.

3. A method according to claim 2, wherein the at least one attribute is selected from a group consisting of source medium, timing of the request, geographical location of the visitor's computing device, type of the visitor's computing device, a web browser of a session and combinations thereof.

4. A method according to claim 1, further comprising:
requesting an analytics server to deliver a code including instructions to select the tracking identifier from the plurality of tracking identifiers associated with the web property; and
executing the code at a web server.

5. A method according to claim 1, further comprising:
automatically receiving instructions from an analytics server to replace the selected tracking identifier with another tracking identifier after a predetermined duration.

6. A method according to claim 1, further comprising:
initiating a communication with an analytics server to determine validity of the selected tracking identifier;
replacing the selected tracking identifier with the another tracking identifier on finding that the selected tracking identifier is no longer valid for the web property; and
retaining the selected tracking identifier on finding that the selected tracking identifier is still valid for the web property.

7. A method according to claim 1, wherein determining the occurrence of the at least one predefined condition comprises:
defining at least one parameter and a corresponding threshold value; and
comparing a measured value of the at least one parameter with the corresponding threshold value to determine occurrence of the predefined condition.

8. A method according to claim 7, wherein an analytics server is configured to define the threshold value for the at least one parameter.

9. A method according to claim 7, wherein the at least one parameter is selected from a group consisting of views limit of the web property, time limit for the tracking identifier and combination thereof.

10. A method according to claim 1, further comprising:
executing the script at the visitor's computing device to collect information corresponding to the visitor's computing device, wherein the information comprises at least a web property view and the tracking identifier; and
sending the information to a statistic collection server.

11. A method according to claim 10, further comprising:
receiving a request from a client's computing device to display usage of the web property;
extracting information associated with each tracking identifier of the web property from the statistic collection server; and
displaying the extracted information on the client's computing device.

12. method for collecting information about usage of a web property, the method comprising steps of:
receiving a request from a web server to deliver a tracking identifier from a plurality of tracking identifiers associated with the web property, wherein the tracking identifier is to be enclosed in a script which is to be embedded in the web property required to be sent to a visitor's computing device;
determining an occurrence of a predefined condition corresponding to usage of the web property;
indicating the web server a first tracking identifier from the plurality of tracking identifiers when the predefined condition has not occurred and a second tracking identifier from the plurality of tracking identifiers when the predefined condition has occurred; and
receiving the usage data of the web property generated on execution of the script at the visitor's computing device.

13. A method according to claim 12, wherein an analytics server is configured to dynamically control the delivery of any tracking identifier from the plurality of tracking identifiers to the web server in accordance with at least one attribute of the visitor's computing device or occurrence of the predefined condition.

14. A method for collecting information about usage of a web property, the method comprising steps of:
transmitting a request to access the web property from a visitor's computing device;
receiving the web property from a web server wherein the web property comprises a script which includes a first tracking identifier corresponding to the web property when a predefined condition has not occurred and a second tracking identifier corresponding to the web property when the predefined condition has occurred;
executing the script to collect information about usage of the web property at the visitor's computing device; and
transmitting the usage data generated on execution of the script to a statistic collection server.

15. A system for collecting information about usage of a web property, the system comprising:
an analytics server configured to deliver a code including instructions to select a tracking identifier from a plurality of tracking identifiers associated with the web property;
a visitor's computing device configured to transmit a request to access the web property; and
a web server configured to:
receive the request to access the web property;
determine an occurrence of at least one predefined condition associated with the web property;
execute the code to select the tracking identifier from the plurality of tracking identifiers based on the occurrence of the at least one predefined condition;
generate a script comprising the selected tracking identifier and instructions to determine usage of the web property at the visitor's computing device; and
transmit the web property embedded with the script and content to the visitor's computing device.

16. A system according to claim 15, wherein the visitor's computing device is configured to:
execute the script to collect information regarding usage of the web property at the visitor's computing device, wherein the information comprises at least a web property view and the tracking identifier; and
send the information to a statistic collection server.

17. A system according to claim 15, wherein the web server is further configured to receive at least one attribute corresponding to the visitor's computing device and determine the occurrence of the at least one predefined condition in accordance with the at least one attribute.

18. A system according to claim 17, wherein the at least one attribute is selected from a group consisting of source medium, timing of the request, geographical location of the visitor's computing device, type of the visitor's computing device, a web browser of a session and combinations thereof.

19. A system according to claim 15, wherein the web server is configured to:
define at least one parameter and a corresponding threshold value; and
compare a measured value of the at least one parameter with the threshold value to determine occurrence of the predefined condition.

20. A system according to claim 19, wherein the at least one parameter is selected from a group consisting of views limit of the web property, time limit for the tracking identifier and combination thereof.
